(19) United States
(12) Patent Application Publication
(10) Pub. No.: US 2018/0206950 A1
(43) Pub. Date: Jul. 26, 2018

(54) DENTAL IMPLANT PROSTHESIS USING DIGITAL LIBRARY AND METHOD FOR MANUFACTURING SAME

(71) Applicant: DIO CORPORATION, Busan (KR)

(72) Inventors: Jin Chul KIM, Yangsan-si (KR); Jin Baek KIM, Busan (KR)

(73) Assignee: DIO CORPORATION, Busan (KR)

(21) Appl. No.: 15/744,583

(22) PCT Filed: Jul. 12, 2016
(86) PCT No.: PCT/KR2016/007540

§ 371 Date: Jan. 12, 2018

(30) Foreign Application Priority Data
Jul. 14, 2015 (KR) 10-2015-0099546

(51) Int. Cl. A61C 13/00; A61C 9/00; A61C 13/34

(52) U.S. Cl. CPC A61C 13/0004; A61C 13/08; A61C 13/34; A61C 9/0053

(57) ABSTRACT

The present disclosure provides a method for manufacturing a dental implant prosthesis using a digital library, the method including a first step of acquiring a three-dimensional integrated image through image matching of a computerized tomography (CT) image and an oral scan image related to an inside of an oral cavity of a person to be treated, a second step of virtually forming a bored hole according to an implant placement position preset in the three-dimensional integrated image, a third step of calculating a set value on the basis of a depth of the bored hole, a fourth step of extracting a single virtual digital one-body abutment corresponding to the set value, and a fifth step of setting a shape-matching portion inside the crown according to three-dimensional outer shape information of the virtually arranged virtual digital one-body abutment.

### TECHNICAL FIELD

The present disclosure relates to a dental implant prosthesis using a digital library and a method of manufacturing the same in which the cost and time required to manufacture a prosthesis are reduced, the economic feasibility of implant surgery is improved, and precision of a manufactured prosthesis is improved.

### BACKGROUND ART

Generally, an implant refers to a replacement capable of substituting for a human tissue when an original human tissue is lost but, in dentistry, refers to implanting an artificial tooth. That is, an implant is an operation in which a fixture formed of a material such as titanium that is not rejected by the human body is implanted in an alveolar bone from which a tooth is lost so that the fixture substitutes for a lost tooth root and fixing an artificial tooth to the fixture to restore functions of the lost tooth.

Specifically, although peripheral teeth and bone are damaged with time in a case of a general prosthesis or denture, an implant may prevent damage to peripheral dental tissues and may be stably used because there is no secondary cause of a dental caries. Also, because an implant has the same structure as that of a natural tooth, the implant does not cause gum pain and foreign body sensation and thus may be semi-permanently used when managed well.

Here, implant surgery is performed by forming a bored hole in an alveolar bone using a drill and placing a fixture in the bored hole, and treatments for forming a bored hole and placing a fixture greatly vary for each patient. This is because a surgical position, depth, and direction of an implant should be determined in consideration of various factors such as a patient's dental conditions, a position of a tooth that requires implant surgery, and a condition of a patient's alveolar bone.

The fixture placed in the bored hole may have various lengths and diameters according to a function of a tooth and bone mass of the alveolar bone, and when an appropriate fixture is selected, a bored hole suitable therefor is formed, and then the fixture is placed. Then, when the placed fixture is fused with the alveolar bone, an abutment is coupled to an upper side of the fixture, and a crown, which is the final prosthesis, is coupled to an upper portion of the abutment such that the surgery is completed.

Here, a shape-matching portion whose shape is matched with a shape of the abutment is disposed inside the crown, and an outer profile of the crown is set to fit teeth arrangement of a person to be treated on the basis of a result of matching an image of an inside of an oral cavity acquired for implant surgery.

A conventional abutment is a readymade provided according to a placed fixture and includes a coupling portion having a lower end coupled to the fixture and an upper end coupled to the shape-matching portion of the crown.

Here, a clearance is formed between the shape-matching portion of the crown and the coupling portion of the abutment for an adhesive to be inserted therebetween. The crown and the abutment may be firmly coupled and durability of the crown may also be improved when the clearance is uniform.

However, a conventional abutment is formed such that a length of the coupling portion has substantially a single size. Thus, the abutment is not sufficiently inserted into the crown in many cases, and a case in which the crown is not properly supported occurs.

The abutment is formed in a direction corresponding to the fixture and is disposed in a direction in which the fixture is placed. Because of this, a case in which the crown is not properly supported occurs when the direction in which the fixture is placed is tilted toward one side according to a condition of an alveolar bone of a person to be treated or the teeth arrangement of the person to be treated is deviated outward or inward from a center of an upper end of the alveolar bone.

That is, because a direction of the abutment is set regardless of the alveolar bone or the teeth arrangement of the person to be treated, the shape-matching portion of the crown is formed at a portion deviating from the center of the crown such that there are problems in that a circumferential thickness of the crown is not uniform, and the crown is easily broken due to a pressure during masticatory movement.

Further, because it is difficult for the shape-matching portion of the crown to be formed such that a uniform clearance is maintained between the shape-matching portion of the crown and the coupling portion of the abutment according to the teeth arrangement, the abutment is not properly inserted into the crown, and the surgery is delayed as much as time taken for re-manufacturing the crown. Even when the abutment is inserted into the crown, firm coupling therebetween is not maintained, the abutment is easily detached from the crown, and there is an inconvenience of requiring revision surgery.

### DISCLOSURE

### Technical Problem

To solve the above problems, it is an objective of the present disclosure to provide a dental implant prosthesis using a digital library and a method of manufacturing the same in which the cost and time required to manufacture a prosthesis are reduced, the economic feasibility of implant surgery is improved, and precision of a manufactured prosthesis is improved.

### Technical Solution

To achieve the above objective, the present disclosure provides a method for manufacturing a dental implant prosthesis using a digital library, the method including a first step of acquiring a three-dimensional integrated image through image matching of a computerized tomography (CT) image and an oral scan image related to an inside of an oral cavity of a person to be treated, a second step of virtually forming a bored hole according to an implant placement position preset in the three-dimensional integrated image, a third step of calculating a first set value on the basis of a depth of the bored hole, calculating a second set value on the basis of a distance from an upper end of the bored hole to an outer surface of gum displayed in the three-dimensional integrated image, and calculating a third set value on the basis of a distance from the outer surface of the gum to an outer surface of a crown set to be continuous with arrangement of peripheral teeth, a fourth step of extracting a single virtual digital one-body abutment corresponding to the first set value, the second set value, and the third set value from the digital library and virtually arranging the extracted single virtual digital one-body abutment in the three-dimensional integrated image, and a fifth step of setting a shape-matching portion inside the crown according to three-dimensional outer shape information of the virtually arranged virtual digital one-body abutment and setting a digital one-body abutment corresponding to the extracted virtual digital one-body abutment.

### Advantageous Effects

By the above technical solution, the dental implant prosthesis using a digital library and a method of manufacturing the same of the present disclosure provides the following advantageous effects.

First, a screw portion placed in a bored hole, a margin portion configured to support a crown, and a coupling portion are integrally disposed in the digital one-body abutment and placed at once such that conventional cumbersome surgery in which a fixture and an abutment are separately coupled can be simplified. Also, because distortion of a fixture, damage to an alveolar bone, and infection due to an introduction of foreign substances caused by an external pressure applied to a coupling portion between conventionally detached parts are fundamentally prevented, safety of the product can be considerably improved.

Second, because a bored hole is virtually formed in the three-dimensional integrated image, by comparing coordinates corresponding to different portions such as an outer surface of an alveolar bone and an outer surface of gum with coordinates of the bored hole, different set values for selecting a single digital one-body abutment from a digital library can be easily calculated by simple arithmetic calculations.

Third, because the single digital one-body abutment corresponding to an inside of an oral cavity of a person to be treated, the digital abutment, and a digital protective cap are selected through a plurality of choices preset to represent various interindividual variations in the digital library, a degree of matching between prostheses is improved, and precise and low-cost implant surgery can be performed.

Fourth, because the crown can be designed and manufactured through three-dimensional vector data of the digital one-body abutment, the digital abutment, and the digital protective cap, a manufacturing cost and time taken for preparation for implant surgery can be reduced, and accurate and firm coupling of the crown is possible through a highly precise product.

### DESCRIPTION OF DRAWINGS

FIG. 1 is a flowchart illustrating a method of manufacturing a dental implant prosthesis using a digital library according to a first embodiment of the present disclosure.

FIG. 2 is an exemplary view illustrating a three-dimensional integrated image in the method of manufacturing the dental implant prosthesis using the digital library according to the first embodiment of the present disclosure.

FIG. 3 is an exemplary view illustrating the digital library in the method of manufacturing the dental implant prosthesis using the digital library according to the first embodiment of the present disclosure.

FIG. 4 is a flowchart illustrating a method of manufacturing a dental implant prosthesis using a digital library according to a second embodiment of the present disclosure.

FIGS. 5A and 5B are exemplary views illustrating the digital library in the method of manufacturing the dental implant prosthesis using the digital library according to the second embodiment of the present disclosure.

FIG. 6 is an exemplary view illustrating a state in which a digital abutment is matched and arranged in an oral scan image in the method of manufacturing the dental implant prosthesis using the digital library according to the second embodiment of the present disclosure.

FIG. 7 is an exemplary view illustrating a state in which outer shape information of a digital abutment is virtually arranged in an oral scan image in the method of manufacturing the dental implant prosthesis using the digital library according to the second embodiment of the present disclosure.

FIG. 8 is an exemplary view illustrating a state in which a crown is set in an oral scan image in the method of manufacturing the dental implant prosthesis using the digital library according to the second embodiment of the present disclosure.

FIG. 9 is an exemplary view illustrating the digital library according to an angle of inclination in the method of manufacturing the dental implant prosthesis using the digital library according to the second embodiment of the present disclosure.

FIG. 10 is an exemplary view illustrating a state in which a digital protective cap is coupled to a digital abutment in the method of manufacturing the dental implant prosthesis using the digital library according to the second embodiment of the present disclosure.

FIG. 11 is an exemplary view illustrating suitability analysis of a digital abutment through a degree of biasness in the method of manufacturing the dental implant prosthesis using the digital library according to the second embodiment of the present disclosure.

### BEST MODE OF THE INVENTION

The best mode of the present disclosure will be described in more detail below with reference to the accompanying drawings.

### Modes of the Invention

Hereinafter, a dental implant prosthesis using a digital library and a method of manufacturing the same according to one preferable embodiment of the present disclosure will be described in detail with reference to the accompanying drawings.

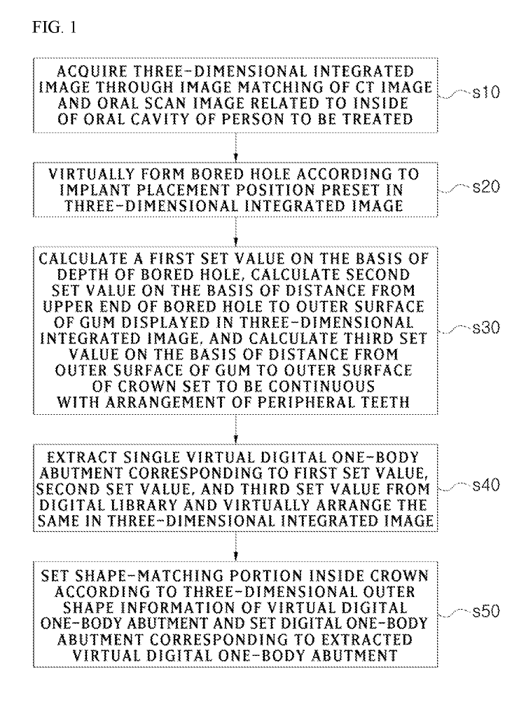

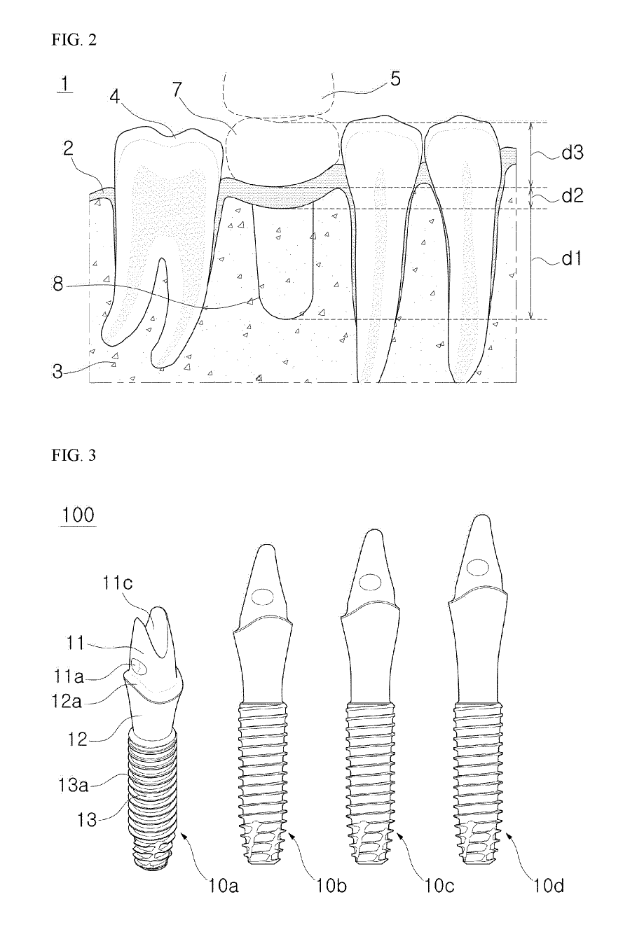

FIG. 1 is a flowchart illustrating a method of manufacturing a dental implant prosthesis using a digital library according to a first embodiment of the present disclosure, FIG. 2 is an exemplary view illustrating a three-dimensional integrated image in the method of manufacturing the dental implant prosthesis using the digital library according to the first embodiment of the present disclosure, and FIG. 3 is an exemplary view illustrating the digital library in the method of manufacturing the dental implant prosthesis using the digital library according to the first embodiment of the present disclosure.

As shown in FIGS. 1 to 3, the method of manufacturing the dental implant prosthesis using the digital library according to the first embodiment of the present disclosure is performed by the following process. Here, preferably, the dental implant prosthesis according to the first embodiment should be understood as a digital one-body abutment in which an abutment and a fixture are integrally formed. Also, preferably, a virtual digital one-body abutment, which will be described below should be understood as digital outer shape information displayed as three-dimensional vector data, and the digital one-body abutment should be understood as a state in which the digital outer shape information is realized and manufactured as a part.

First, a three-dimensional integrated image 1 is acquired through image matching of a computerized tomography (CT) image and an oral scan image related to an inside of an oral cavity of a person to be treated (S10).

Here, the CT image includes information on a tissue having a high density such as a crown, a root, and an alveolar bone of a tooth obtained by CT scan. The oral scan image includes information on a shape of gum of a tooth exposed outside the gum. Here, the oral scan image may be acquired by directly scanning the inside of the oral cavity of the person to be treated using an oral scanner.

In some cases, the oral scan image may also be acquired by scanning a dental impression model in which the oral cavity of the person to be treated is molded in intaglio or scanning a plaster model formed on the basis of the dental impression model. Further, the oral scan image may be acquired by reversing a scanned image of the intagliated dental impression model to be convexly embossed.

Here, the CT image and the oral scan image may be acquired in a state in which a tooth at an implant placement position is extracted or in a state before the tooth is extracted. Here, when each of the images is acquired in the state before the tooth is extracted, a processing process in which a tooth to be extracted is removed may be additionally performed on the image.

When the oral scan image and the CT image are acquired, the two images may be matched on the basis of a common part. Here, the common part may be based on a crown of a tooth, and when a reference marker is installed inside the oral cavity of the person to be treated, the oral scan image and the CT image may be matched on the basis of an image of the reference marker.

Here, each of the images may be digitized and stored in a storage device. The images may be made to overlap on the basis of an image processing program, and the three-dimensional integrated image 1 in which pieces of information on gums and alveolar bones in the images are connected on the basis of the common part may be acquired. Accordingly, the three-dimensional integrated image 1 may include integrated information on an implant placement position, bone mass, bone density, and distribution of an alveolar bone at an adjacent portion of the implant placement position, a thickness of gum at each part of the alveolar bone, and the like.

When the three-dimensional integrated image 1 is acquired (S10), a bored hole 8 is virtually formed according to the implant placement position preset in the three-dimensional integrated image 1 (S20).

Here, the implant placement position refers to a portion in which an artificial tooth is to be placed through implant surgery, and there may be a single implant placement position or a plurality of implant placement positions.

Specifically, when the three-dimensional integrated image 1 is acquired, a suitable outer shape and arrangement angle of a crown 7 may be set in consideration of a space between peripheral teeth 4 around the implant placement position, a height of a masticatory surface of an opposing tooth 5 facing the implant placement position, and the like.

A direction and depth of the bored hole 8 may be calculated according to the arrangement angle of the crown 7 and the bone mass and distribution of the alveolar bone at the implant placement position, a neural position at a lower portion of the alveolar bone, and the like, and the bored hole 8 is virtually formed to pass through an outer surface of an alveolar bone 3.

Here, a diameter of the bored hole 8 may be set to have an average numerical value suitable for implant placement in normal adult males and females and may also be set according to a type of an artificial tooth that is to be placed in the implant placement position and a masticatory pressure.

When the diameter, direction, and depth of the bored hole 8 are set, the bored hole 8 may be formed into a three-dimensional image and may be virtually formed in the three-dimensional integrated image 1 corresponding to the implant placement position.

When the bored hole 8 is virtually formed (S20), a first set value is calculated on the basis of the depth of the bored hole 8, and a second set value is calculated on the basis of a distance d2 from an upper end of the bored hole 8 to an outer surface of gum 2 displayed in the three-dimensional integrated image 1. Also, a third set value is calculated on the basis of a distance d3 from the outer surface of the gum 2 to an outer surface of the crown 7 set to be continuous with arrangement of the peripheral teeth 4 (S30).

Here, preferably, the depth of the bored hole 8 should be understood as a distance d1 from an outer surface of the alveolar bone 3 displayed in the three-dimensional integrated image 1 to a lower end portion of the virtually formed bored hole 8.

In this way, each of the set values may be easily calculated by simple arithmetic calculations in which three-dimensional coordinates corresponding to different portions such as the outer surface of the alveolar bone 3 and the outer surface of the gum 2 are compared with coordinates of the bored hole 8 virtually formed in the three-dimensional integrated image 1.

Lengths of lower portions of digital one-body abutments 10a, 10b, 10c, and 10d having a support force suitable for an implant placement position may be set through the first set value. Further, lengths of margin portions 12 of the digital one-body abutments 10a, 10b, 10c, and 10d may be set through the second set value, and lengths of coupling portions 11 thereof may be set through the third set value.

When each of the set values is calculated (S30), a single virtual digital one-body abutment corresponding to the first set value, the second set value, and the third set value is extracted from a digital library 100 and is virtually arranged in the three-dimensional integrated image 1 (S40).

Here, preferably, the digital library 100 should be understood as a database including pieces of outer shape information on the digital one-body abutments 10a, 10b, 10c, and 10d having various shapes.

Specifically, a screw portion 13 placed in the bored hole to substitute for a root of a tooth is formed at the lower portion of the digital one-body abutment 10a. Also, the margin portion 12 having a profile continuous with a surface of the gum and configured to prevent introduction of foreign substances into the gum is disposed above the screw portion 13. Further, the coupling portion 11 configured to support the crown 7 is disposed above the margin portion 12.

That is, the digital one-body abutment 10a is a prosthesis in which the screw portion 13, the margin portion 12, and the coupling portion 11 are integrally disposed and, preferably, should be understood as a conventional prosthesis in which a fixture and an abutment are integrally formed.

The digital library 100 may be a database related to pieces of digital outer shape information of the plurality of digital one-body abutments 10a, 10b, 10c, and 10d each having the screw portion 13, the margin portion 12, and the coupling portion 11 differentiated according to the set values integrally disposed.

Here, the digital library 100 may be differentiated by choices including the first set value, the second set value, and the third set value. For example, the digital library 100 may include pieces of outer shape information of the plurality of digital one-body abutments differentiated according to the first set value, and each of the pieces of outer shape information of the digital one-body abutments differentiated according to the first set value may be differentiated again according to the second set value. Also, each of the pieces of outer shape information of the digital one-body abutments differentiated according to the first set value and the second set value may be differentiated again according to the third set value.

In this way, the length of the screw portion 13 may be selected according to the first set value, the length of the margin portion 12 may be selected according to the second set value, and the length of the coupling portion 11 may be selected according to the third set value. When each of the set values is set, outer shape information of a single digital one-body abutment may be selected.

In this way, the length of each of the screw portion 13, the margin portion 12, and the coupling portion 11 of the digital one-body abutment 10a may be determined from the digital library 100 according to each of the set values. Accordingly, a single digital one-body abutment suitable for the inside of the oral cavity of the person to be treated may be immediately selected through the digital library 100 even without a separate design or measurement task.

Here, the pieces of outer shape information of the digital one-body abutments 10a, 10b, 10c, and 10d in the digital library 100 may include screw portion lengths, margin portion lengths, and coupling portion lengths having sizes capable of representing interindividual variations on pieces of information on an alveolar bone, gum, and teeth of adult males and females. The virtual digital one-body abutment, in which pieces of outer shape information of a digital one-body abutment selected according to the set values are formed into an image, may be virtually arranged in the three-dimensional integrated image 1 so that the shape of the screw portion 13 is matched with that of the bored hole 8.

In this way, pieces of outer shape information of the plurality of digital one-body abutments representing interindividual variations are included in the digital library 100, and a single digital one-body abutment suitable for the inside of the oral cavity of the person to be treated is extracted using the plurality of set values. Accordingly, precision of a prosthesis for implant surgery is improved, and an additional cost and time required to select a fixture for each individual and design an abutment suitable therefor are reduced, thereby improving the economic feasibility.

Further, because three-dimensional vector data of the digital one-body abutment may be directly linked to manufacturing a crown, a crown may be designed and a suitable digital one-body abutment may be immediately selected and provided only using an image acquired at the time of planning implant surgery. Therefore, a cost for manufacturing the implant prosthesis and time required for preparing for implant surgery may be considerably reduced.

Here, digital outer shape information of each of the digital one-body abutments may be in the form of three-dimensional vector data, displayed in the form of an image in the three-dimensional integrated image 1 through simple coordinate conversion, and be used as design information for manufacture. That is, a selected digital one-body abutment may be manufactured whenever needed using the three-dimensional vector data or may be pre-manufactured for each size.

In some cases, in Step S30 in which each of the set values are calculated, a fourth set value may be further calculated according to a type of an artificial tooth that is to be placed in the implant placement position and a masticatory pressure. Also, the digital library may further include pieces of digital outer shape information of digital one-body abutments in which diameters of screw portions are different according to the fourth set value.

A shape-matching portion is set inside the crown according to three-dimensional outer shape information of the virtual digital one-body abutment virtually arranged in the bored hole, and a digital one-body abutment corresponding to the extracted virtual digital one-body abutment is set (S50). Here, preferably, setting the digital one-body abutment should be understood as including directly manufacturing the digital one-body abutment by using the three-dimensional vector data of the digital library 100 or selecting a pre-manufactured digital one-body abutment.

Specifically, whether the virtual digital one-body abutment, which is virtually arranged, is suitable for a preset crown may be determined after an outer surface of the screw portion disposed at the lower portion of the virtual digital one-body abutment is moved within the image so that the shape of the outer surface of the screw portion matches a shape of an inner surface of the bored hole.

Whether the coupling portion of the virtual digital one-body abutment is accurately positioned inside the crown may be checked. Here, when it is determined that the digital one-body abutment is suitable for a preset crown, the shape-matching portion inside the crown may be immediately designed using the three-dimensional vector data corresponding to the coupling portion of the digital one-body abutment.

In this way, by displaying a single digital one-body abutment selected according to each of the set values in the digital library 100 in the three-dimensional integrated image, whether the digital one-body abutment is suitable for the teeth arrangement of the person to be treated may be easily determined. When the digital one-body abutment is suitable for the teeth arrangement, the shape-matching portion inside the crown may be set using outer shape information of the selected digital one-body abutment, and thus a highly precise product may be provided.

When the shape-matching portion inside the crown is set, the crown may be manufactured using the preset outer shape information of the crown.

Specifically, an outer shape of the crown 7 may be set according to the arrangement of the peripheral teeth 4 and the height of the masticatory surface of the opposing tooth 5 facing the implant placement position displayed in the three-dimensional integrated image 1.

The shape-matching portion is a portion into which the coupling portion of the digital one-body abutment is inserted. Preferably, a boundary surface of the shape-matching portion is disposed so that the shape thereof matches a shape of an upper surface of the margin portion, and a side surface of the crown is formed to be continuous with a boundary surface of the margin portion.

Here, preferably, a clearance into which an adhesive material for fixing the crown is inserted is formed between the inner surface of the shape-matching portion of the crown and the outer surface of the coupling portion. Here, when the clearance is formed with a uniform thickness between the inner surface of the shape-matching portion and the outer surface of the coupling portion, the crown and the digital one-body abutment may be firmly coupled.

Further, three-dimensional outer shape information on the selected digital one-body abutment is pre-stored in the digital library. Accordingly, because the shape of the shape-matching portion of the crown may be simultaneously set when the digital one-body abutment is selected, time required to design and manufacture the crown may be considerably reduced. The digital one-body abutment 10a includes the screw portion 13, the margin portion 12, and the coupling portion 11.

Here, a length of the screw portion 13 is selected by digital outer shape information extracted from the digital library 100 according to the above-described first set value while the screw portion 13 is integrally disposed at a lower portion of the digital one-body abutment to be placed in the bored hole.

Specifically, the screw portion 13 is placed in the bored hole formed in the alveolar bone and serves as a root of a tooth. Here, preferably, the diameter of the screw portion 13 gradually narrows downward, and an edge of a lower end portion of the screw portion 13 is formed to be rounded.

Accordingly, a lower portion of the screw portion 13 may be easily inserted into the bored hole without interfering with an inside of the bored hole. Also, because an upper portion of the screw portion 13 which is formed to be wide is adhered to an inner circumference of an upper portion of the bored hole, the screw portion 13 may be stably fused to the alveolar bone without moving inside the bored hole.

A screw thread 13a is formed at an outer circumference of a side portion of the screw portion 13. Preferably, a vertical thickness of the screw thread 13a gradually increases upward.

Specifically, the screw portion 13 is rotatably inserted into the bored hole, and a screw groove corresponding to the screw thread 13a is formed at an inner circumference of the bored hole. Here, because the screw thread 13a at the lower portion side of the screw portion 13 is formed with a small thickness, the screw groove may be easily formed. Because the screw thread 13a is formed to gradually become thicker toward the upper portion of the screw portion 13, a coupling force between the alveolar bone and the screw portion 13 may be improved.

A length of the margin portion 12 is selected by outer shape information extracted from the digital library 100 according to the above-described second set value while the margin portion 12 has an upper surface 12a integrally disposed with the upper portion of the screw portion 13 and formed to be continuous with the surface of the gum. Accordingly, the margin portion 12 may prevent introduction of foreign substances into the gum while the digital one-body abutment 10a is placed.

Preferably, the upper surface 12a of the margin portion 12 protrudes outward in a radial direction from an outer surface of the coupling portion 11 so that the upper surface 12a is stepped with the coupling portion 11. Accordingly, the margin portion 12 may support a lower end of the crown coupled to the coupling portion 11 so that the crown may be more stably coupled.

A length of the coupling portion 11 is selected by digital outer shape information extracted from the digital library 100 according to the above-described third set value while the coupling portion 11 is integrally disposed with the upper portion of the margin portion 12 and is formed such that the shape of the coupling portion 11 matches that of the shape-matching portion of the crown.

Here, the length of the coupling portion 11 suitable for the crown may be set according to the third set value, and the coupling portion 11 may have an outer surface having a clearance for an adhesive material to be inserted between the outer surface and the shape-matching portion. Further, because the outer surface of the coupling portion 11 is roughened, a coupling force through the adhesive material filled between the shape-matching portion of the crown and the outer surface of the coupling portion may be further improved.

Here, a locking groove portion 11a recessed inward in the radial direction may be formed in the side portion of the coupling portion 11 so that a protective cap, which is a temporary prosthesis before the crown is coupled, is temporarily fixed. Further, when a protrusion whose shape is matched with that of the locking groove portion 11a is formed also at the inner surface of the crown, temporary fixing is possible when the crown is being coupled such that the crown may be stably coupled, and because a contact area between the coupling portion 11 and the crown is increased, the coupling portion 11 and the crown may be more firmly fixed.

Preferably, a fastening groove 11c recessed downward to be engaged with a rotating tool is formed at an upper portion of the coupling portion 11. That is, as the digital one-body abutment 10a receives a rotary force of the rotating tool through the fastening groove 11c, the screw portion 13 may be rotatably coupled to the bored hole.

In this way, the digital one-body abutment 10a according to the first embodiment of the present disclosure is manufactured and provided such that the screw portion 13 placed in the bored hole, the margin portion 12 configured to support the crown, and the coupling portion 11 are integrated as a single body. Therefore, a cumbersome surgical process in which a fixture is placed in a bored hole and then an abutment is separately coupled is omitted, and an implant surgery process may be simplified.

Because distortion of a fixture, damage to an alveolar bone, and the like that may be caused by a force applied from outside when detached parts are being coupled may be prevented, prompt and stable surgery is possible. Also, because problems such as deterioration in durability, infection, or the like that may be caused by introduction of foreign substances into a gap formed during the coupling may be fundamentally prevented, safety of the product can be improved.

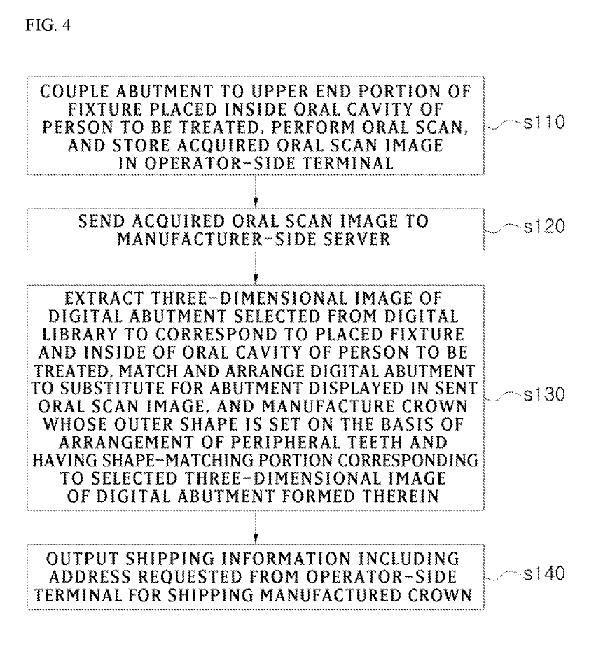

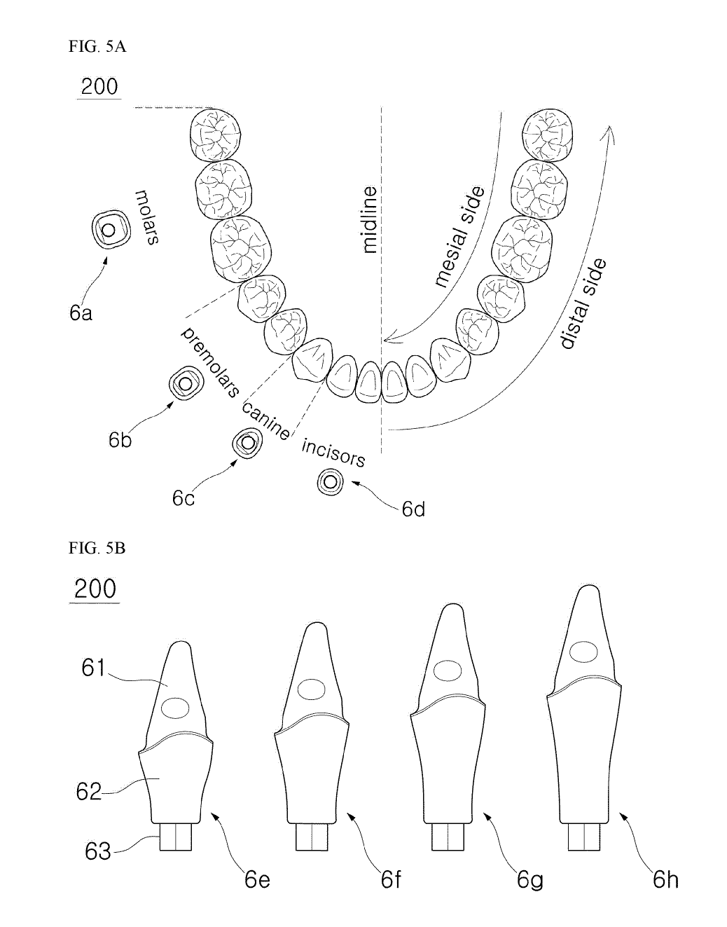

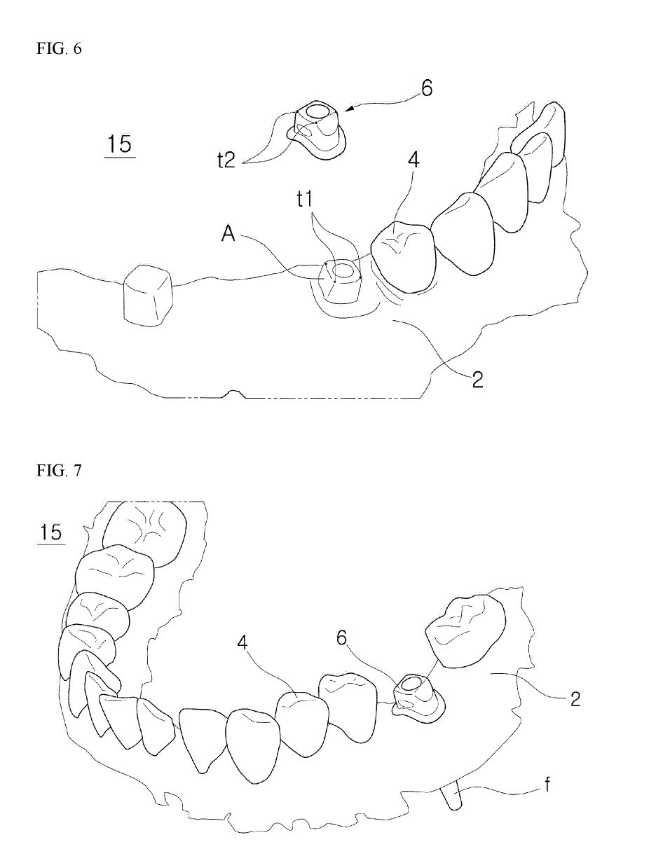

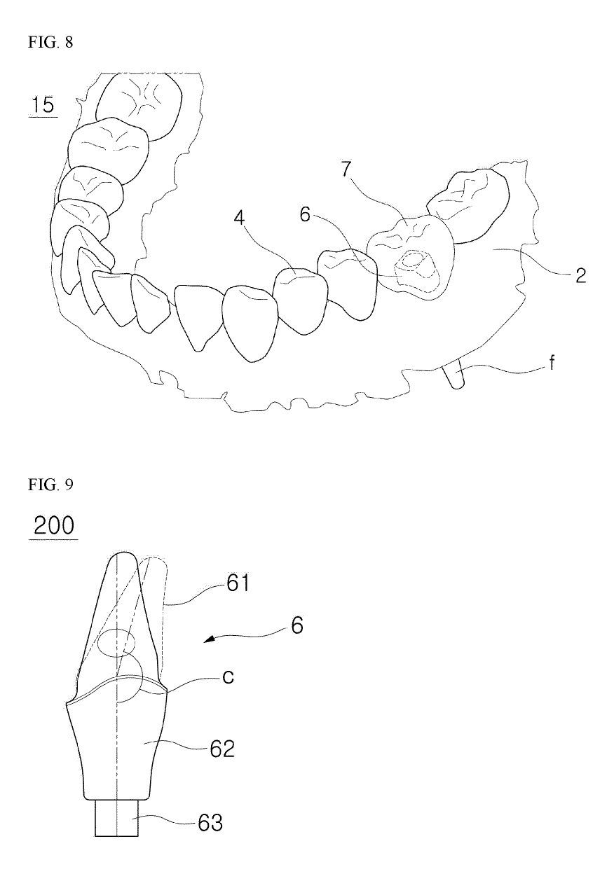

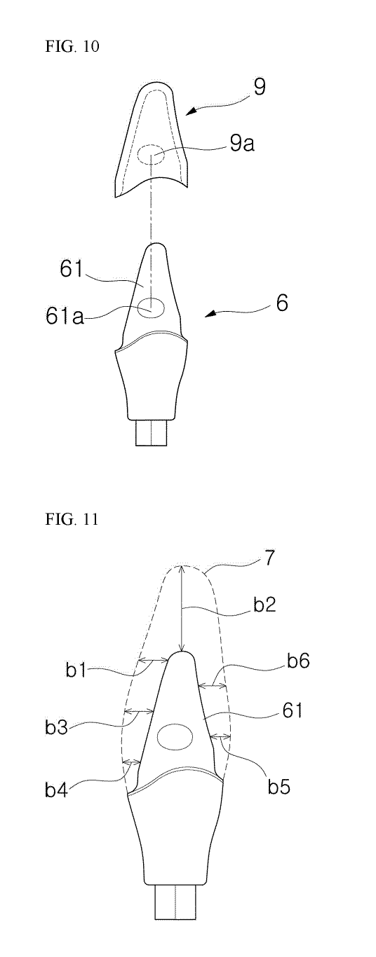

FIG. 4 is a flowchart illustrating a method of manufacturing a dental implant prosthesis using a digital library according to a second embodiment of the present disclosure, and FIGS. 5A and 5B are exemplary views illustrating the digital library in the method of manufacturing the dental implant prosthesis using the digital library according to the second embodiment of the present disclosure. FIG. 6 is an exemplary view illustrating a state in which a digital abutment is matched and arranged in an oral scan image in the method of manufacturing the dental implant prosthesis using the digital library according to the second embodiment of the present disclosure, and FIG. 7 is an exemplary view illustrating a state in which outer shape information of a digital abutment is virtually arranged in an oral scan image in the method of manufacturing the dental implant prosthesis using the digital library according to the second embodiment of the present disclosure. FIG. 8 is an exemplary view illustrating a state in which a crown is set in an oral scan image in the method of manufacturing the dental implant prosthesis using the digital library according to the second embodiment of the present disclosure, FIG. 9 is an exemplary view illustrating the digital library according to an angle of inclination in the method of manufacturing the dental implant prosthesis using the digital library according to the second embodiment of the present disclosure, and FIG. 10 is an exemplary view illustrating a state in which a digital protective cap is coupled to a digital abutment in the method of manufacturing the dental implant prosthesis using the digital library according to the second embodiment of the present disclosure.

As shown in FIGS. 4 to 10, the method of manufacturing the dental implant prosthesis using the digital library according to the second embodiment of the present disclosure is performed by the following process. Here, preferably, the dental implant prosthesis according to the second embodiment of the present disclosure should be understood as a digital abutment and a crown coupled to an upper end portion of a fixture.

First, an abutment A is coupled to an upper end portion of a fixture placed inside an oral cavity of a person to be treated, oral scan is performed, and an acquired oral scan image is stored in an operator-side terminal (S110).

Specifically, when an implant placement position is set according to an implant surgery plan, a fixture having a size corresponding to the set position is selected. Here, a product standardized according to a type of a tooth and a thickness of an alveolar bone according to the implant placement position may be used as the fixture.

A depth and direction in which the fixture is placed may be calculated according to bone mass and thickness of the alveolar bone and a type of a tooth to be substituted, and a CT image may be further acquired through CT scan to acquire more detailed information on the inside of the oral cavity.

Here, information on a standardized fixture may be converted into a three-dimensional vector image and then stored in the operator-side terminal. Here, preferably, the operator-side should be understood as a general individual dental clinic in which implant surgery is substantially performed. The operator-side terminal is a medium configured to store information on the inside of the oral cavity of the person to be treated acquired by the operator and may be a personal computer (PC) or a separate computation device. The information on the inside of the oral cavity of the person to be treated includes the oral scan image data or text data in which details checked by visual inspection are recorded.

Here, the operator-side terminal is connected to a manufacturer-side server, which will be described below, through wired and wireless communication networks such that information stored in the operator-side terminal and information stored in the manufacturer-side server may be exchanged with each other.

Here, preferably, the manufacturer-side should be understood as an implant surgery support center in which a prosthesis and the like required for the implant surgery are manufactured using data received from the operator-side terminal. The manufacturer-side server may be a device in which information received from the operator-side terminal and information pre-stored for manufacturing a prosthesis are included and may put the pieces of information together and design an implant surgery prosthesis suitable for a person to be treated.

Preferably, the abutment A coupled to an upper end portion of the placed fixture should be understood as a general abutment that is standardized as a readymade and released. Specifically, the abutment A includes a coupling protrusion coupled to a coupling groove formed at the upper end portion of the fixture and a margin portion formed above the coupling protrusion and arranged inside gum. Further, the abutment A includes a coupling portion formed above the margin portion and inserted into a shape-matching groove formed inside the crown to fix and support the crown.

A through-hole passing through a central portion in a longitudinal direction of the abutment A is formed in the abutment A. Here, the abutment A is fastened to the upper end portion of the fixture by a coupler inserted into the abutment A through the through-hole such that the abutment A is fixed to the fixture.

An oral scan of the inside of the oral cavity of the person to be treated in which the abutment A is coupled to the upper end portion of the fixture is performed, and an acquired oral scan image 15 is stored in the operator-side terminal. Here, the oral scan image 15 includes outer image information of the coupling portion of the abutment A coupled to the upper end portion of the fixture and shape image information of the peripheral teeth 4 around the abutment A.

Here, because the oral scan image 15 is acquired while the abutment A is coupled to the upper side of the fixture, more accurate position information may be provided in comparison to when an oral scan image is acquired in a state in which only the fixture is placed.

The oral scan image 15 stored in the operator-side terminal is sent to the manufacturer-side server (S120).

Specifically, in the oral scan image 15, the shape of the inside of the oral cavity of the person to be treated in which the outer shape of the coupling portion of the abutment A is displayed may be formed into an image using three-dimensional vector data, and an image of a fixture f may be further included by being virtually arranged.

Here, because the abutment A displayed in the oral scan image 11 is conventionally standardized as a readymade and released, there is a problem in that the abutment A is unable to be suitably applied in different situations according to interindividual variations and types of teeth of a person to be treated. Accordingly, a degree to which the shape of the abutment A matches that of the crown is lowered, and there is a problem in that the abutment A is not well-fitted between the fixture and the crown. Because of this, a result of implant surgery is undesirable, and an inconvenience in which revision surgery is required occurs.

Because information displayed in the oral scan image 15 further includes unnecessary noise information such as saliva and foreign substances according to environment inside an oral cavity, precision is decreased, and the oral scan image 15 is substantially not suitable for designing a shape-matching portion for coupling of the crown.

Thus, a method for solving the above-described problem is provided in the present embodiment.

Specifically, a virtual digital abutment selected from a digital library 200 to correspond to the fixture f and the inside of the oral cavity of the person to be treated is extracted. Then, the selected virtual digital abutment is matched and arranged to substitute for the abutment A displayed in the sent oral scan image 15. Then, the crown 7 whose outer shape is set on the basis of arrangement of the peripheral teeth 4 and having a shape-matching portion corresponding to the selected virtual digital abutment formed therein is manufactured (S130).

Here, preferably, the digital abutment is understood as an abutment, in which lengths of a margin portion 62 and a coupling portion 61 are diversified according to a type and form of a tooth, the abutment being standardized by calculating shapes that may represent interindividual variations. Here, the digital abutment may include a plurality of digital abutments to correspond to different types of teeth, and the plurality of digital abutments may constitute a single set and be provided to an operator.

That is, the operator may select a single digital abutment 6 suitable for an implant placement position of the person to be treated from the plurality of digital abutments corresponding to different types and forms of teeth. In this way, a case in which an implant does not match that may occur due to the conventional general abutment A being provided in a single uniform size and side effects following the case may be prevented, and a highly precise product may be provided. Further, because a complicated procedure and a high cost due to conventionally directly designing an abutment and manufacturing the abutment for each individual may be simplified and reduced, it is economically feasible.

Here, a digital abutment 6e includes a coupling protrusion 63, the margin portion 62, and the coupling portion 61.

Specifically, the coupling protrusion 63 is formed in a shape corresponding to that of an inner surface of the coupling groove formed at the upper end portion of the fixture.

The margin portion 62 formed above the coupling protrusion 63 may be disposed inside gum and have an upper surface whose outer shape is continuous with a surface of the gum. In this way, the margin portion 62 may be prevented from being exposed through a portion between the crown and the gum such that an esthetic sense is improved, and introduction of foreign substances or a case in which an implant does not match caused by variations between the margin portion 62 and the gum may be prevented.

The coupling portion 61 is formed above the margin portion 62 and is inserted into the crown to fix and support the crown. Further, a coupler may be inserted into the digital abutment through a through-hole formed to pass through a central portion of the digital abutment and may be coupled and fixed to the upper end portion of the fixture.

Here, each of the digital abutments 6a, 6b, 6c, 6d, 6e, 6f, 6g, and 6h are included according to the digital library 200, which is preset. Here, preferably, the digital library 200 includes pieces of digital outer shape information of the plurality of digital abutments having types of teeth, and lengths of the margin portion 62 and the coupling portion 61 as choices.

Specifically, the pieces of digital outer shape information of the digital abutments are diversified into various choices to selectively correspond to various conditions such as types and shapes of teeth, gum conditions, and arrangement relationships with peripheral teeth. Also, shapes of digital abutments that may represent various interindividual variations of each of the choices may be calculated, standardized, and included in the digital library 200.

Further, referring to FIG. 5A, the digital abutments 6a, 6b, 6c, and 6d are formed to have cross-sectional shapes that may represent masticatory surfaces of molars, premolars, canines, and incisors according to types of teeth. Also, as illustrated in FIG. 5B, various digital abutments in which the length of the margin portion 62 and the length of the coupling portion 61 are different may be provided.

That is, a single digital abutment may be included in a set according to the digital library 200 in which digital abutments are diversified through the choices, and a digital abutment may be selected by setting choices to correspond to the fixture and the inside of the oral cavity.

Here, pieces of digital outer shape information of the digital abutments may be stored in the manufacturer-side server by pieces of three-dimensional vector data, in which unique outer shapes of the digital abutments are digitized, being preset in the digital library 200. Further, the three-dimensional vector data may be displayed in image data required for implant surgery through a simple coordinate conversion.

Specifically, when lengths of the margin portion and the coupling portion corresponding to the fixture and the inside of the oral cavity are input in the digital library 200, a single digital abutment suitable for the input lengths is extracted.

In this way, because a digital abutment having a shape suitable for implant surgery may be promptly selected and used in the surgery, time taken for the surgery may be considerably shortened. Also, because the time and cost required for processing an abutment to correspond to the fixture and the inside of the oral cavity of the person to be treated may be reduced, the economic feasibility may be considerably improved.

Furthermore, the lengths of the margin portion and the coupling portion may be encoded, and a unique model number may be assigned to each of the digital abutments and stored in the digital library 200. In this way, when only the model number is input, three-dimensional outer shape information of a single digital abutment selected from the digital library 200 may be easily received.

A three-dimensional image of the digital abutment 6 suitable for implant surgery on the person to be treated may be selected from the digital library 200 in consideration of the arrangement of the peripheral teeth 4 displayed in the oral scan image 15 and the outer shape information of the abutment A. Here, because the digital abutment 6 is extracted by setting choices corresponding to the fixture and the inside of the oral cavity of the person to be treated, the digital abutment 6 may be easily linked to designing the crown. In this way, a separate dental impression taking process may be omitted, and manufacturing time and manufacturing cost may be reduced.

Further, because an image of the abutment A displayed with low precision on the oral scan image 15 is substituted with the image of the digital abutment, the outer shape information of the digital abutment is substantially used in designing the crown 7. Accordingly, accuracy and precision in designing the crown 7 may be considerably improved.

Here, in the digital abutment 6e, the type of tooth is selected corresponding to a position in which the fixture is placed, and the length of the margin portion 62 is selected on the basis of information of the placed fixture and a depth to which the fixture is placed. Further, the length of the coupling portion 61 may be selected corresponding to the arrangement of the peripheral teeth and an interval between consecutive placement spaces.

Here, preferably, the placement space should be understood a substantially empty space, corresponding to the implant placement position, between peripheral teeth present at both sides of a lost tooth and an upper surface of gum at a lower side of the empty space.

For example, when a position in which the fixture is placed is a portion from which a premolar is lost, a single digital abutment corresponding to the premolar may be selected. The length of the margin portion 62 may be determined according to the depth to which the fixture is placed and the shape of the gum. Further, the length of the coupling portion 61 may be determined corresponding to a shape and height of a peripheral tooth present at any one side of the placement space.

Here, the choices may be set so that a degree to which a shape of a digital abutment matches that of the crown 7 designed according to the arrangement of the peripheral teeth is high and a pressure applied to the crown 7 during masticatory movement is minimal. Accordingly, the single most suitable digital abutment may be selected from the digital library 200. Further, because a plurality of at least two or more choices are set, a digital abutment whose shape is more suitable for an implant surgery site may be selected.

The virtual digital abutment 6 extracted from the digital library 200 may be matched and arranged to substitute for the abutment A displayed in the sent oral scan image 15. Here, a portion of the virtual digital abutment 6 corresponding to the image of the abutment A may be determined, and the virtual digital abutment 6 may be matched to correspond to the image of the abutment A.

Specifically, a three-dimensional image corresponding to the selected virtual digital abutment 6 is extracted from the digital library 200 and output as a three-dimensional image on the oral scan image 15. Then, portions on the oral scan image 15 and the three-dimensional image of the virtual digital abutment 6 that correspond to each other are automatically determined using a matching program, and a matching task is performed through image matching. In this way, the three-dimensional image of the virtual digital abutment 6 may be located at a substantial implant placement position inside the oral cavity of the person to be treated.

For example, as illustrated in FIG. 6, a plurality of sites at which positions of the margin portion or the coupling portion of the abutment A displayed in the oral scan image 15 and the margin portion or the coupling portion on the three-dimensional image of the virtual digital abutment 6 are similar to each other may be set, and the sites may be input as matching reference points t1 and t2.

Alternatively, because the through-hole formed in the abutment A and the through-hole formed in the virtual digital abutment 6 are formed in substantially the same size, the abutment A and the virtual digital abutment 6 may be matched with each other using one side or a midline of each of the through-holes as matching targets.

When the image of the abutment A displayed in the oral scan image 15 is erased, the oral scan image 15 from which the arrangement relationships between the peripheral teeth and the virtual digital abutment 6 may be calculated may be acquired.

Here, when designing the crown 7, only an upper surface profile of the margin portion and outer shape information of the coupling portion of the virtual digital abutment 6 are required. Therefore, the three-dimensional image of the virtual digital abutment 6 displayed in the oral scan image 15 may be limited to an image of the upper surface of the margin portion and an image of the outer surface of the coupling portion.

Here, the outer surface of the coupling portion of the digital abutment and the inner surface of the shape-matching portion of the crown 7 should be designed such that the shapes of the two substantially match each other. Therefore, in place of the inaccurate image of the abutment A, the three-dimensional outer shape information of the virtual digital abutment 6 extracted from the digital library 200 may be used, and the crown 7 may be promptly and precisely designed.

Also, an inconvenience of having to take a dental impression model corresponding to the inside of the oral cavity of the person to be treated may be solved, and because design information for manufacturing the crown 7 may be acquired from only the above-described data and image information, a preparation for manufacturing a dental implant prosthesis and a task of manufacturing the same may be simplified.

An outer shape of the crown 7 suitable for the implant placement position may be set according to the arrangement of the peripheral teeth 4 displayed on the oral scan image 15 and a masticatory surface of an opposing tooth facing the implant placement position. Specifically, a width of the crown 7 may be set according to a space between the peripheral teeth 4, and a length and a masticatory surface of the crown 7 may be set according to the opposing tooth. For this, preferably, a shape of an outer surface of the opposing tooth facing the implant placement position as well as the implant placement position are included in the oral scan image 15.

Here, the shape-matching portion is a portion into which the coupling portion 61 of the digital abutment is inserted. The shape-matching portion is set so that a shape of a boundary surface thereof matches a shape of the upper surface of the margin portion 62 and an outer surface thereof is continuous with a side surface of the margin portion 62. Then, a clearance into which an adhesive material for fixing the crown is inserted is formed between the inner surface of the shape-matching portion and the outer surface of the coupling portion 61.

Here, because the three-dimensional outer shape information on the digital abutment is preset and stored in the digital library 200, the shape of the shape-matching portion of the crown 7 may be formed in conjunction with selection of the digital abutment.

Accordingly, time taken for designing and manufacturing the crown may be considerably reduced, and because a portion between the inner surface of the shape-matching portion and the outer surface of the coupling portion is uniformly formed, the crown and the digital abutment may be firmly coupled to each other.

In the case of the conventional customized abutment which is designed for each individual, a complicated and cumbersome procedure is required, and because of this, a design cost and a manufacturing cost are high. On the other hand, in the present disclosure, a complicated and cumbersome process may be omitted through the digital library 200, and a precise, low-cost implant may be supplied.

Referring to FIG. 9, the choices in the digital library 200 may further include an angle of inclination c of the coupling portion according to types of teeth.

Specifically, although interindividual variations are low in cases of molars or premolars disposed at side portions inside the oral cavity, interindividual variations are generally present according to inclinations of teeth in cases of canines or incisors disposed at front portions inside the oral cavity. Therefore, when an implant placement position corresponds to a canine or an incisor, the angle of inclination c of the coupling portion may be further included in the choices.

Here, the angle of inclination c of the coupling portion may be selected corresponding to an angle connecting a central portion passing through the longitudinal direction of the margin portion, i.e., a midline of the through-hole, and a central portion of a placement space continuous with the arrangement of the peripheral teeth.

Accordingly, because the digital library 200 having a wide variety of choices capable of corresponding to teeth arrangement variations of different individuals may be provided, a digital abutment which is matched better may be selected, and precise implant surgery is possible.

After the crown is designed and manufactured from the oral scan image in which the selected virtual digital abutment is included, shipping information including an address requested from the operator-side terminal for shipping the manufactured crown is output (S140).

Specifically, together with the single digital abutment selected from the digital library 200, the crown 7 set and manufactured as described above is shipped to the operator-side in which the implant surgery is performed.

Here, for the crown to be accurately shipped to the operator-side, preferably, shipping information of the operator-side is output from the operator-side terminal. Here, the shipping information includes the operator-side information requested for receiving the crown.

Specifically, when storing the oral scan image 15 in the operator-side terminal, the operator may also store pieces of information such as an address to which the completed crown is to be shipped and a name of an operator in the operator-side terminal. By combining such pieces of information, transmitting the combined pieces of information to the manufacturer-side, and managing the combined pieces of information, the manufactured crown may be accurately shipped to a requested address and an operator even when many kinds of prostheses are simultaneously manufactured.

Further, when shipping the manufactured crown, the crown may be shipped after adding the digital abutment 6 used in manufacturing the crown and information on the digital abutment 6. Accordingly, the operator may perform more prompt and accurate implant surgery by referring to accurate information of the manufactured crown.

Here, the manufacturer may ship the manufactured crown and the selected digital abutment together to the operator-side or may ship the manufactured crown and send information on the digital abutment to the operator-side terminal.

After acquiring the information on the digital abutment received from the manufacturer-side server, the operator may select a single digital abutment corresponding to the sent digital abutment information from the set included in the digital library included in the operator-side and use the selected single digital abutment.

A surgical guide may be manufactured so that the fixture is placed at an accurate position with an accurate depth. Here, the surgical guide may include a fixing groove portion whose shape is matched corresponding to a shape of the inside of the oral cavity of the person to be treated and a guide hole formed along the implant placement position. That is, by being placed along an inner circumference of the guide hole, the fixture may be placed in an accurate position without being misaligned. In this way, the abutment A, the digital abutment 6, and the crown coupled to the upper portion of the fixture may be placed to be naturally continuous with the arrangement of the peripheral teeth.

Here, after a dental impression model of an inside of the oral cavity is taken, the surgical guide may be designed on the basis of the dental impression model. Alternatively, the surgical guide may be designed by image matching between the oral scan image and a CT image acquired through CT scan.

The abutment placed above the fixture may be a digital abutment corresponding to the virtual digital abutment selected from the digital library. Also, the oral scan image may be acquired in a state in which the digital abutment and a digital protective cap selected to correspond to the digital abutment are coupled to each other and then may be stored in the operator-side terminal.

Specifically, when the fixture is placed in the alveolar bone of the person to be treated, and the digital abutment is temporarily coupled to the upper end portion of the fixture, the digital protective cap may be coupled to an upper end of the digital abutment. Here, the digital protective cap may be selected from the digital library to correspond to the digital abutment.

Specifically, referring to FIG. 10, the digital protective cap may have a mounting groove formed therein so that the digital abutment corresponding thereto is inserted thereinto and may have a lower end whose shape matches that of the upper surface of the margin portion of the digital abutment.

Here, a protrusion shape-matching groove 61a recessed inward may be formed in outer surfaces at both sides of the coupling portion 61 of the digital abutment 6, a protrusion 9a may protrude from a position corresponding to the protrusion shape-matching groove 61a in the mounting groove of the digital protective cap 9, and the protrusion 9a and the protrusion shape-matching groove 61a may be coupled to each other.

The digital library may further include pieces of inner shape information of a plurality of digital protective caps having the types of teeth and the lengths of the coupling portion as choices. Here, preferably, the inner shape information should be understood as information on shapes of the mounting groove and the protrusion inside the digital protective cap. An outer shape of the digital protective cap may be set to have a predetermined thickness from an inner surface of the mounting groove.

Here, because the digital protective cap shares the choices of the digital abutment, when the digital abutment is selected, the digital protective cap may be selected without separate additional information.

That is, the fixture may be selected when the implant placement position, the type of tooth, the shape and bone mass of the alveolar bone, and the like are analyzed. Then, the digital abutment may be selected when the cross-sectional shape of the coupling portion is selected using the analyzed type of tooth, the length of the margin portion is selected using the thickness and outer shape of gum, and the length of the coupling portion is selected using the arrangement of peripheral teeth.

A single digital protective cap may be selected by sharing pieces of information on selections of the type of tooth and the length of the coupling portion.

That is, using a few choices according to an implant surgery plan, a single digital abutment corresponding to the fixture and the inside of the oral cavity of the person to be treated and a digital protective cap configured to protect the digital abutment are selected from the digital library and immediately provided.

Accordingly, after the fixture is placed, even when a healing abutment, which is a middle prosthesis, is omitted and a digital abutment, which is the final prosthesis, is fastened during a bone fusion period, the digital protective cap may be coupled to the digital abutment, and contamination or deformation of the digital abutment due to foreign substances may be prevented. In this way, safety of implant surgery may be improved, a surgical process may be simplified such that time taken for surgery is reduced, and surgical convenience may be improved.

By one-touch coupling between the protrusion shape-matching groove 61a and the protrusion 9a of the digital protective cap 9 and the digital abutment 6, upper surfaces of the coupling portion and the margin portion of the digital abutment 6 may be safely protected.

Here, shape information and shape-matching information of each of the digital abutment 6 and the digital protective cap 9 may be acquired before the placing of the fixture.

Here, preferably, the shape information should be understood as three-dimensional vector data of the digital abutment and the digital protective cap, and the shape information may be converted into design information of the digital abutment and the digital protective cap.

Preferably, the shape-matching information should be understood as information that may indicate a coupling relationship between the digital abutment and the digital protective cap. That is, the shape-matching information may be calculated using the arrangement form of the outer profile of the coupling portion and the inner profile of the mounting groove while the digital abutment and the digital protective cap are coupled to each other.

In sending selection information on the digital abutment and the digital protective cap and the oral scan image to the manufacturer-side server, the shape information and the shape-matching information may be sent instead of the selection information.

When the oral scan image is sent from the operator-side terminal, the selection information on the digital abutment and the digital protective cap may be further sent to the manufacturer-side server.

Here, preferably, the selection information should be understood as information that allows the digital abutment and the digital protective cap to be extracted from the digital library. That is, the digital abutment, which is already used in surgery, and the digital protective cap may be chosen through the selection information and be extracted from the digital library.

Specifically, the same digital library may be included in the manufacturer-side server and the operator-side terminal. Alternatively, the digital library may be included in the manufacturer-side server, and the operator-side terminal may connect to the manufacturer-side server and use the digital library.

Here, digital shape information of the digital abutment and the digital protective cap having the same size may be extracted from the manufacturer-side server and the operator-side terminal using the selection information.

Here, the selection information may include types of teeth and shape-matching information corresponding to each other between the digital abutment and the digital protective cap selected from the digital library.

Specifically, the selection information may include the type of tooth, the length of the margin portion, and the length of the coupling portion. The digital abutment may be selected using the type of tooth, the length of the margin portion, and the length of the coupling portion, and the digital protective cap may be selected using the type of tooth and the length of the coupling portion.

That is, the digital abutment and the digital protective cap selected using the selection information are coupled so that shapes of outer surfaces and inner surfaces thereof match each other. Accordingly, when the shape-matching information is used, a position of the digital abutment may be restored with respect to the digital protective cap.

In the manufacturing of the crown (S130), the virtual digital abutment selected from the digital library may be acquired as below. First, three-dimensional position information of the digital protective cap displayed in the oral scan image is calculated. Then, the virtual digital abutment may be acquired on the basis of an inner profile of the virtual digital protective cap extracted from the digital library and matched on the basis of the three-dimensional position information.

Here, the calculation of the three-dimensional position information of the digital protective cap is a step for replacing the digital protective cap displayed in the oral scan image with the virtual digital protective cap extracted from the digital library.

That is, the virtual digital protective cap may be matched and arranged to substitute for the digital protective cap displayed in the oral scan image on the basis of the selection information and the three-dimensional position information.

Therefore, even when the digital protective cap mounted inside the oral cavity of the person to be treated is damaged due to foreign substances or deformation, the three-dimensional position information of the digital protective cap may be extracted and, and the digital protective cap may be replaced with the virtual digital protective cap. In this way, the position of the digital protective cap placed inside the oral cavity of the person to be treated may be accurately analyzed.

Here, because the virtual digital protective cap is visually displayed in the oral scan image, additional position analysis is possible through operator-side or manufacturer-side experts. In this way, because the position of the virtual digital protective cap may be more accurately set, pieces of shape information of the digital protective cap placed inside the oral cavity and the virtual digital protective cap virtually arranged in the oral scan image may be precisely matched.

In some cases, a three-dimensional position of the virtual digital abutment may be set using shape-matching information between the digital protective cap and the digital abutment with respect to the extracted three-dimensional position information, and the set three-dimensional position of the virtual digital abutment may be directly linked to manufacturing the crown.

The three-dimensional position information of the digital protective cap displayed in the oral scan image may be calculated as below.

First, selection on an alignment reference point is received on the image of the digital protective cap displayed in the oral scan image. Then, on the virtual digital protective cap extracted from the digital library using the selection information, an alignment reference point may be set at a position corresponding to that of the selection-received alignment reference point in the image of the digital protective cap.

Here, because three or more of each of the alignment reference points are set on the digital protective cap and the virtual digital protective cap, by matching the alignment reference points, the digital protective cap and the virtual digital protective cap may be more accurately matched.

The virtual digital protective cap is virtually arranged so that the alignment reference points overlap.

Then, when the position of the virtual digital protective cap is set, the virtual digital abutment corresponding to the selection information of the virtual digital protective cap is extracted from the digital library. Then, the position of the virtual digital abutment may be set on the basis of the position and shape information of the virtual digital protective cap.

Here, by virtually arranging the virtual digital abutment in the oral scan image, virtually arranging design information of the crown together, and performing visual analysis, a more precise crown may be manufactured. In some cases, the virtual digital abutment may not be directly displayed in the oral scan image and outer shape information of the virtual digital abutment may be immediately linked to manufacturing of the crown.

Here, the selection information may further include three-dimensional shape information of the fixture. That is, by matching positions of the coupling protrusion at the lower portion of the digital abutment and the coupling groove at the upper end of the fixture, a virtual fixture corresponding to the fixture may be virtually arranged at a lower portion of the virtual digital abutment.

When setting a position of the virtual digital abutment, aligning an outer profile of the digital abutment on the basis of the inner profile of the virtual digital protective cap may be included.

Specifically, on the basis of shape information in the digital library, three-dimensional coordinates of the inner surface of the mounting groove and three-dimensional coordinates of the outer shape of the coupling portion may be acquired.

By three-dimensionally moving the virtual digital abutment so that the three-dimensional coordinates of the coupling portion overlap the three-dimensional coordinates of the mounting groove, the position of the virtual digital abutment may be set. Accordingly, because the position of the virtual digital abutment in the oral scan image may be set on the basis of the virtual digital protective cap, a substantial position of the digital abutment placed inside the oral cavity of the person to be treated may be easily analyzed.

Further, the position of the virtual digital abutment may also be set by calculating and matching position information of the protrusion formed inside the virtual digital protective cap and position information of the protrusion shape-matching portion formed at an outer portion of the virtual digital abutment so that the shape of the protrusion is matched with that of the protrusion shape-matching portion.

In some cases, the image of the fixture may be virtually arranged in the three-dimensional integrated image acquired by matching the oral scan image and the CT image. Also, a single digital abutment corresponding to the image of the fixture and the inside of the oral cavity of the person to be treated may be selected from the digital library. Further, the crown may have the shape-matching portion set therein on the basis of the three-dimensional outer shape information of the selected digital abutment and have an outer shape set on the basis of the arrangement of the peripheral teeth. Such a modification belongs to the scope of the present disclosure.

FIG. 11 is an exemplary view illustrating suitability analysis of a digital abutment through a degree of biasness in the method of manufacturing the dental implant prosthesis using the digital library according to the second embodiment of the present disclosure.

As illustrated in FIG. 11, suitability of the digital abutment may be analyzed through degrees of biasness M, b2, b3, b4, and b5.

Specifically, the degrees of biasness M, b2, b3, b4, and b5 from an outer profile of an image of the crown 7 corresponding to arrangement of peripheral teeth to an outer surface of a digital abutment 61 are calculated. Then, when a minimal value of the degrees of biasness is a preset reference value or larger, a single suitable digital abutment may be selected. Here, preferably, the degrees of biasness M, b2, b3, b4, and b5 should be understood as distances from the outer profile of the image of the crown 7 to the outer surface of the digital abutment 61.

That is, whether the digital abutment is arranged close to the center of the crown and whether any portion of the crown is formed too thin may be determined using the degrees of biasness M, b2, b3, b4, and b5. Then, when the minimal value of the degrees of biasness M, b2, b3, b4, and b5 is a preset reference value or smaller, the digital abutment may be determined as having been inappropriately selected, and another digital abutment may be re-extracted.

As described above, the present disclosure is not limited to the embodiments described above, the present disclosure may be modified and practiced by one of ordinary skill in the art to which the present disclosure pertains without departing from the scope of the present disclosure defined by the claims, and such modifications also belong to the scope of the present disclosure.

### INDUSTRIAL APPLICABILITY

By providing a dental implant prosthesis using a digital library and a method of manufacturing the same, the present disclosure is applicable to an industry for dental implant surgery.

1. A method for manufacturing a dental implant prosthesis using a digital library, the method comprising:
a first step of acquiring a three-dimensional integrated image through image matching of a computerized tomography (CT) image and an oral scan image related to an inside of an oral cavity of a person to be treated;
a second step of virtually forming a bored hole according to an implant placement position preset in the three-dimensional integrated image;
a third step of calculating a first set value on the basis of a depth of the bored hole, calculating a second set value on the basis of a distance from an upper end of the bored hole to an outer surface of gum displayed in the three-dimensional integrated image, and calculating a third set value on the basis of a distance from the outer surface of the gum to an outer surface of a crown set to be continuous with arrangement of peripheral teeth;
a fourth step of extracting a single virtual digital one-body abutment corresponding to the first set value, the second set value, and the third set value from the digital library and virtually arranging the extracted single virtual digital one-body abutment in the three-dimensional integrated image; and
a fifth step of setting a shape-matching portion inside the crown according to three-dimensional outer shape information of the virtually arranged virtual digital one-body abutment and setting a digital one-body abutment corresponding to the extracted virtual digital one-body abutment.

2. The method of claim 1, wherein, in the fourth step, the digital library includes pieces of digital outer shape information of a plurality of digital one-body abutments each having a screw portion, a margin portion, and a coupling portion differentiated according to the first set value, the second set value, and the third set value integrally disposed.

3. The method of claim 2, wherein the fourth step includes:
selecting a length of the screw portion, which is disposed at a lower portion of the virtual digital one-body abutment and placed in the bored hole, according to the first set value;
selecting a length of the margin portion, which is integrally disposed with an upper portion of the screw portion and has an upper surface continuous with a surface of the gum, according to the second set value; and
selecting a length of the coupling portion, which is integrally disposed with an upper portion of the margin portion and inserted so that a shape thereof matches that of the shape-matching portion of the crown, according to the third set value.

4. A method for manufacturing a dental implant prosthesis using a digital library, the method comprising:
a first step of coupling an abutment to an upper end portion of a fixture placed inside an oral cavity of a person to be treated, performing oral scan, and storing an acquired oral scan image in an operator-side terminal;
a second step of sending the oral scan image stored in the operator-side terminal to a manufacturer-side server;
a third step of extracting a virtual digital abutment selected from the digital library to correspond to the fixture and the inside of the oral cavity of the person to be treated, matching and arranging the extracted virtual digital abutment to substitute for an image of the abutment displayed in the sent oral scan image, and manufacturing a crown whose outer shape is set on the basis of arrangement of peripheral teeth and having a shape-matching portion corresponding to the selected digital abutment formed therein; and
a fourth step of outputting shipping information including an address requested from an operator-side terminal for shipping the manufactured crown.

5. The method of claim 4, wherein, in the third step, the digital library includes pieces of outer shape information of a plurality of digital abutments having types of teeth and lengths of the margin portion and the coupling portion as choices.

6. The method of claim 5, wherein:
in the third step, the choices further include an angle of inclination of the coupling portion according to the types of teeth; and
the angle of inclination of the coupling portion is selected corresponding to an angle connecting a central portion of the margin portion and a central portion of a placement space continuous with arrangement of peripheral teeth.

7. The method of claim 5, wherein:
in the third step, in the digital abutment, the type of a tooth is selected corresponding to a position in which the fixture is placed;
the length of the margin portion is selected on the basis of information of the placed fixture and a depth to which the fixture is placed; and
the length of the coupling portion is selected corresponding to the arrangement of the peripheral teeth and an interval between consecutive placement spaces.

8. The method of claim 4, wherein:
in the first step, the abutment is a digital abutment corresponding to the virtual digital abutment selected from the digital library, and the oral scan image is acquired while the digital abutment and a digital protective cap selected to correspond to the digital abutment are coupled to each other;
in the second step, selection information of the digital abutment and the digital protective cap stored in the operator-side terminal is further sent to the manufacturer-side server; and
in the third step, three-dimensional position information of the image of the digital protective cap displayed in the oral scan image is calculated, and a position of the virtual digital abutment selected from the digital library is set on the basis of an inner profile of a virtual digital protective cap which is extracted according to the selection information from the digital library and matched on the basis of the three-dimensional position information.

9. The method of claim 8, wherein, in the second step, the selection information includes types of teeth and shape-matching information corresponding to each other between the digital abutment and the digital protective cap selected from the digital library.

10. The method of claim 8, wherein, in the first step, the digital library includes pieces of outer shape information of the plurality of digital abutments having types of teeth and lengths of the margin portion and the coupling portion as choices and pieces of inner shape information of a plurality of digital protective caps having the types of teeth and the lengths of the coupling portion as choices.

11. The method of claim 8, wherein the third step includes:
receiving selection on an alignment reference point on the image of the digital protective cap; and
matching an alignment reference point of the extracted virtual digital protective cap to overlap the selection-received alignment reference point and virtually arranging the virtual digital protective cap.

12. The method of claim 8, wherein, in the third step, in the virtual digital abutment, an outer profile of the virtual digital abutment is aligned with respect to the inner profile of the virtual digital protective cap.

13. The method of claim 4, wherein, in the first step, in a surgical guide manufactured including a fixing groove portion whose shape is matched corresponding to a shape of the inside of the oral cavity of the person to be treated and a guide hole formed along a fixture placement position, the fixture is placed along an inner circumference of the guide hole.

14. A dental implant prosthesis using a digital library, the dental implant prosthesis, which is formed as one-body, comprising:
a screw portion whose length is selected by digital outer shape information extracted from a digital library according to a first set value calculated on the basis of a depth of a bored hole virtually formed to correspond to a preset implant placement position in a three-dimensional integrated image acquired through image matching of a CT image and an oral scan image related to an inside of an oral cavity of a person to be treated, the screw portion being integrally disposed with a lower portion of the dental implant prosthesis to be placed in the bored hole;
a margin portion whose length is selected by digital outer shape information extracted from the digital library according to a second set value calculated on the basis of a distance from an upper end of the bored hole virtually formed in the three-dimensional integrated image to an outer surface of gum, the margin portion integrally disposed with an upper portion of the screw portion and having an upper portion continuous with a surface of the gum; and
a coupling portion whose length is selected by digital outer shape information extracted from the digital library according to a third set value calculated on the basis of a distance from the outer surface of the gum to an outer surface of a crown set to be continuous with arrangement of peripheral teeth, the coupling portion integrally disposed with an upper portion of the margin portion and inserted so that a shape thereof matches that of the shape-matching portion of the crown.

15. The dental implant prosthesis of claim 14, wherein:
the digital library includes pieces of digital outer shape information of a plurality of digital one-body abutments each having the screw portion, the margin portion, and the coupling portion differentiated according to the first set value, the second set value, and the third set value integrally disposed; and
a fastening groove recessed downward to be engaged with a rotating tool is formed at an upper portion of the coupling portion.
